(19) United States
(12) Patent Application Publication
(10) Pub. No.: US 2007/0132595 A1
(43) Pub. Date: Jun. 14, 2007

(54) Transponder device with mega pads

(75) Inventor: Roland Schropp, Erlenbach (DE)

Correspondence Address: MCGRATH, GEISSLER, OLDS & RICHARDSON, PLLC, P.O. BOX 1364, FAIRFAX, VA, 22038-1364, US

(73) Assignee: ATMEL Germany GmbH

(21) Appl. No.: 11/636,694

(22) Filed: Dec. 11, 2006

(30) Foreign Application Priority Data
Dec. 9, 2005 (DE) 10 2005 058 977.4

(51) Int. Cl. G08B 13/14

(52) U.S. Cl. 340/572.8

(57) ABSTRACT

A transponder device is disclosed that includes an integrated circuit device, a coil configured for coupling to an electromagnetic field, and at least one discrete capacitor including contact areas. The capacitor is bonded to the integrated circuit device and to the coil through the contact areas.

This nonprovisional application claims priority under 35 U.S.C. § 119(a) on German Patent Application No. DE 102005058977, which was filed in Germany on Dec. 9, 2005, and which is herein incorporated by reference.

### BACKGROUND OF THE INVENTION

1. Field of the Invention

This description relates to a transponder device.

2. Description of the Background Art

The vast majority of RFID systems sold operate on the principle of inductive coupling. An inductively coupled transponder consists of an electronic data carrier, generally a single microchip, and a large-area coil or conductive loop that serves as the antenna.

Inductively coupled transponders generally are operated passively. For example, the energy necessary to operate the microchip is made available by the reader. Accordingly, the antenna coil of the reader generates a strong, high-frequency field that passes through the cross-section of the coil area and the space around the coil.

A small portion of the transmitted field passes through the antenna coil of the transponder, which is located at a distance from the reader. As a result, the voltage Ui is generated at the antenna coil of the transponder by induction. This voltage is rectified and serves as the power supply for the transponder. A capacitor C is connected in parallel with the antenna coil of the reader. The capacitance of the capacitor C is selected to form, together with the coil inductance of the antenna coil, a parallel resonant circuit with a resonant frequency that corresponds to the transmission frequency of the reader.

The antenna coil of the transponder, together with the capacitor C1, also forms a resonant circuit that is tuned to the transmission frequency of the reader. The voltage U at the transponder coil reaches a maximum through resonant rise in the parallel resonant circuit. The transmitting/receiving device of the transponder and that of the base station may-be implemented as a series resonant circuit, for example, a series circuit of coil and capacitor.

In transponder devices with magnetic coupling, the implementation of the coil may be problematic, since a certain coil size is required as a function of the range of the transponder. Accordingly, the range of the transponder also determines the size of the transponder as well. Since the connecting wires of the coil still have a certain thickness even for miniaturized transponders, it may be difficult to bond the wires to the semiconductor circuits without damaging or destroying the circuits in the process. Moreover, a coil has a relatively high mass, e.g., in comparison to the circuit, so that a rigid mechanical connection is typically required.

EP 0 588 944 B1, which corresponds to U.S. Pat. No. 5,223,851, describes a method for producing a miniaturized transponder device, wherein the connecting wires of the antenna are connected directly to an integrated circuit device. Enlarged external contact areas are provided on the circuit device on an additional insulating layer to protect the circuit device from excessive heat and mechanical stresses during the bonding process. In contrast, standard contact areas of the circuit device are located beneath the additional insulating layer. For this reason, openings are made again later in the insulating layer for an electrical contact between the standard contact areas and the enlarged external contact areas above the insulating layer.

Moreover, U.S. Pat. No. 5,541,399 describes a transponder device in which the integrated circuit device and the capacitor of the input circuit are located on a carrier board, called a PCB (printed circuit board). Although the receiving coil is also attached to the PCB, the production of the carrier board is relatively complex and expensive.

### SUMMARY OF THE INVENTION

One object is to provide a transponder device wherein the coil is connected in a simple and economical manner.

In one general aspect, a transponder device includes an integrated circuit device, a coil configured for coupling to an electromagnetic field, and at least one discrete capacitor including contact areas. The capacitor is bonded to the integrated circuit device and to the coil through the contact areas.

Embodiments of this aspect may include one or more of the following features. For example, the capacitor may include at least two capacitors connected together. The capacitor or capacitors may be individual semiconductor components.

The contact areas may include integrated circuit device contact areas and coil wire contact areas. The contact areas may be sized relative to connecting wires operatively connected to the connected contact areas. The coil wire contact areas may be relatively larger than the integrated circuit device contact areas. The integrated circuit device contact areas may be on opposite sides of the capacitor from the coil wire contact areas. The integrated circuit device contact areas and the coil wire contact areas may be on the same side of the capacitor. The integrated circuit device and the capacitor comprise a stacked configuration.

The integrated circuit device, the coil, and the capacitor may be located on a carrier film. The integrated circuit device, the coil, and the capacitor may include a laminated configuration. The integrated circuit device, the coil, and the capacitor are surrounded by a molded material.

One advantage of the foregoing transponder device is that it is not necessary to use both a complicated carrier board and additional protective layers on the integrated circuit device.

Another advantage is achieved by providing different contact areas on the capacitor for the electrical connection to the integrated circuit arrangement and to the coil. In this regard, the contact areas in each case are matched to the size of the connecting wires and bond wires to be attached. Thus, the size of the coil wires has the result that the contact areas for contacting the coil are significantly larger than those for contacting or bonding the integrated circuit arrangement.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 a top view of a transponder device.

FIG. 2 is a side view of the transponder device of FIG. 1.

FIG. 3 is a side view of a transponder device.

### DETAILED DESCRIPTION

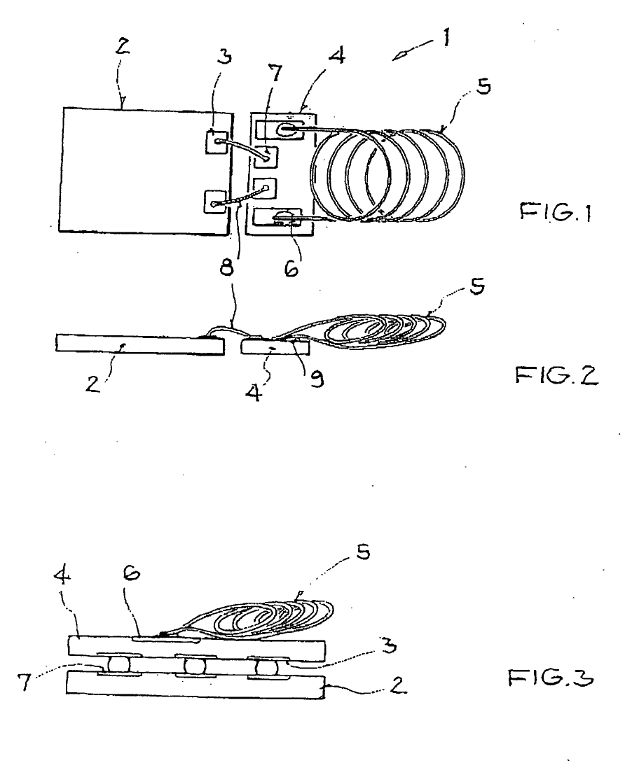

Referring to FIG. 1, a transponder device 1 includes an integrated circuit device 2 and a coil 5 for coupling to a magnetic field. A capacitor 4 is arranged between the coil 5 and the integrated circuit device 2 to form a resonant receiving circuit together with the coil 5. The capacitor 4 is connected to the coil 5 and to the integrated circuit device 2 with a bonding element, for example, with bond wires 8. Contact areas 7, 3 are provided on the capacitor 4 and on the integrated circuit device 2, respectively. The contact areas 7, 3 are sized appropriately for adequately connecting the capacitor 4 and integrated circuit device 2 with the bond wires 8. The coil 5 is connected to the capacitor 4 with contact areas 6 that have a relatively larger surface area to accommodate the diameter of the wire of the coil 5.

Referring to FIG. 2, a contact bump 9, e.g., a solder bump of gold, is provided for each electrical connection to the ends of the wire of the coil 5. The contact bumps 9 ensure that a reliable connection of the wires 5 is achieved through a thermocompression process. A reliable connection between the solder bumps 9 and the contact areas 6 is produced by application of relatively low heat and force. Alternatively, one or more of the coil wires of the coil 5 may be bonded to the contact areas 6 without solder bumps.

Referring to FIG. 3, the capacitor 4 can be connected to the integrated circuit device 2 through a flip-chip technique, and for only the coil wires to be connected to contact areas 6. The contact areas 6 on the capacitor 4 for the coil 5 and the contact areas 3 for the integrated circuit device 2 are located on opposite sides, i.e. the upper and lower sides, of the capacitor 4. In this case, contact areas 7 are formed on an upper surface of the integrated circuit device 2 and can be connected through bonding elements, for example solder bumps or bond wires, to the contact areas 3 on a lower surface of the capacitor 4. The flip-chip technique is advantageous to achieve a transponder with a stacked construction.

A number of embodiments have been described. Nevertheless, it will be understood that various modifications may be made without departing from the spirit and scope of the invention. For example, a transponder device that includes an integrated circuit device, a coil for coupling to an electromagnetic field, and at least one discrete capacitor that has an electrical connection to the integrated circuit device and to the coil, e.g., the coil is bonded to contact areas of the capacitor, does not require a complicated carrier board and/or additional protective layers on the integrated circuit device.

The bonding elements, which may include bond wires or solder bumps, permit the joining together of materials, components, and/or connecting elements. For example, a micro pressure welding process may be used in which materials of the same type, similar, and/or of different types are joined together in the solid state through the time-limited application of pressure and temperature and/or ultrasound. In this process, a wire or a strip is connected to a terminal area or contact area on a chip, and is routed to the corresponding contact points of another component for connection thereto, e.g., connection to a capacitor. Bonding may be accomplished by a thermocompression process, soldering process, and/or an ultrasonic process supported by various types of energy supply.

The transport of heat into the integrated circuit device, which may arise in one or more of the aforementioned bonding processes, e.g., during a thermocompression or soldering process, may damage the semiconductor components. However, undesirable heat transfer is minimized or controlled in the foregoing embodiments by spatially separating the capacitor 4 from the integrated circuit device 2. Accordingly, the transponder 1 is provided with greater stability with regard to mechanical and thermal effects as adequate separation from the integrated circuit device 2 during bonding of the coil wires is ensured.

The flexibility of transponder production can be increased because, as a function of the requirements for the resonant circuit, a capacitor with relatively larger or smaller capacitance can be selected with the same integrated circuit device when compared to a transponder where a capacitor is directly integrated into the integrated circuit device. Accordingly, the foregoing embodiments provided a transponder that is robust and relatively inexpensive, as it can be complicated and expensive to vary the capacitor during the production process when directly integrated into the integrated circuit device.

The capacitor may include one or more capacitors. For example, two or more capacitors may be connected together so that multiple capacitors can be connected in parallel or in series as a function of the requirements of the transponder's resonant circuit. Accordingly, different capacitor designs can be created without the need to undertake changes to the integrated circuit device or semiconductor components.

The capacitor can be provided as an individual semiconductor component in the transponder device. For example, during the production process for the integrated circuit, a capacitor is produced adjacent to the integrated circuit on the wafer. In order to reduce manufacturing costs, it is also possible to produce the capacitor by a separate technology process especially adapted to the manufacture of capacitors.

It may be advantageous to provide different contact areas on the capacitor for the electrical connection to the integrated circuit device and to the coil. For example, the contact areas in each case can be matched to the size of the connecting wires and bond wires that are attached to the respective contact area. Accordingly, the size of the coil wires results in the contact areas for contacting the coil are significantly larger than those for contacting or bonding the integrated circuit arrangement.

The integrated circuit device, the coil and the capacitor can be located are located on a carrier film. For example, partially completed transponders can be fixed in place while keeping the space requirement as small as possible during the manufacturing process.

A lamination can be provided for the integrated circuit device, the coil and the capacitor. In addition to the carrier film, a cover film can be provided and is fixed to the carrier film in a close-fitting manner. The films are then brought to a soft elastic state in a laminating system with the application of heat and high pressure, and are cured therein into an inseparable composite.

The integrated circuit device, the coil, and/or the capacitor can be surrounded by a molded material. The use of the molded material improves the stability of typically brittle and easily breakable semiconductor components.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transponder device, comprising:
an integrated circuit device;
a coil configured for coupling to an electromagnetic field; and
at least one discrete capacitor including contact areas, the capacitor being bonded to the integrated circuit device and to the coil through the contact areas.

2. The transponder device according to claim 1, wherein the capacitor comprises at least two capacitors connected together.

3. The transponder device according to claim 1, wherein the at least one capacitor is an individual semiconductor component.

4. The transponder device according to claim 2, wherein the two capacitors are individual semiconductor components.

5. The transponder device according to claim 1, wherein the contact areas comprise integrated circuit device contact areas and coil wire contact areas, said contact areas being sized relative to connecting wires operatively connected to the contact areas.

6. The transponder device according to claim 5, wherein the coil wire contact areas are relatively larger than the integrated circuit device contact areas.

7. The transponder device according to claim 5, wherein the integrated circuit device contact areas are on opposite sides of the capacitor from the coil wire contact areas.

8. The transponder device according to claim 5, wherein the integrated circuit device contact areas and the coil wire contact areas are on a same side of the capacitor.

9. The transponder device according to claim 7, wherein the integrated circuit device and the capacitor comprise a stacked configuration.

10. The transponder device according to claim 1, wherein the integrated circuit device, the coil, and the capacitor are located on a carrier film.

11. The transponder device according to claim 1, wherein the integrated circuit device, the coil, and the capacitor comprise a laminated configuration.

12. The transponder device according to claim 1, wherein the integrated circuit device, the coil, and the capacitor are surrounded by a molded material.

13. The transponder device according to claim 6, wherein the integrated circuit device, the coil, and the capacitor are located on a carrier film.

14. The transponder device according to claim 6, wherein the integrated circuit device, the coil, and the capacitor comprise a laminated configuration.

15. The transponder device according to claim 6, wherein the integrated circuit device, the coil, and the capacitor are surrounded by a molded material.
